(19) United States
(12) Patent Application Publication
(10) Pub. No.: US 2024/0286610 A1
(43) Pub. Date: Aug. 29, 2024

(54) DRIVER NOTIFICATIONS DURING DRIVING EVENTS

(71) Applicant: QUALCOMM Incorporated, San Diego, CA (US)

(72) Inventor: Annika LARSSON, Goteborg (SE)

(21) Appl. No.: 18/307,532

(22) Filed: Apr. 26, 2023

Related U.S. Application Data
(60) Provisional application No. 63/487,177, filed on Feb. 27, 2023.

(51) Int. Cl. B60W 30/14; B60W 30/09; B60W 30/095; B60W 30/18; B60W 50/00; B60W 50/14; H04W 4/40

(52) U.S. Cl. CPC B60W 30/143; B60W 30/09; B60W 30/0956; B60W 30/18154; B60W 50/0097; B60W 50/14; H04W 4/40; B60W 2050/143; B60W 2050/146; B60W 2556/45

(57) ABSTRACT

A method of driving assistance at a device is disclosed herein. The method includes identifying that a vehicle is approaching a driving event based on sensor data while the vehicle is operating. The method includes computing a time to arrival at the driving event based on the sensor data. The method includes adjusting at least one of an acceleration value or a position of the vehicle with respect to the driving event based on the sensor data and the time to arrival at the driving event being equal to a threshold value.

### CROSS REFERENCE TO RELATED APPLICATION(S)

This application claims the benefit of and priority to U.S. Provisional Application Ser. No. 63/487,177, entitled “DRIVER NOTIFICATIONS DURING DRIVING EVENTS” and filed on Feb. 27, 2023, which is expressly incorporated by reference herein in its entirety.

### TECHNICAL FIELD

The present disclosure relates generally to communication systems, and more particularly, to driving assistance systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and at least one processor coupled to the memory and, based at least in part on information stored in the memory, the at least one processor is configured to identify that a vehicle is approaching a driving event based on sensor data while the vehicle is operating; compute a time to arrival at the driving event based on the sensor data; and adjust at least one of an acceleration value or a position of the vehicle with respect to the driving event based on the sensor data and the time to arrival at the driving event being equal to a threshold value.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of wireless communication between wireless devices based on sidelink (SL) communication in accordance with various aspects of the present disclosure.

FIG. 5A is a diagram illustrating an example of a first resource allocation mode for SL communication in accordance with various aspects of the present disclosure.

FIG. 5B is a diagram illustrating an example of a second resource allocation mode for SL communication in accordance with various aspects of the present disclosure.

FIG. 6 is a diagram illustrating an example structure of a sidelink resource pool in accordance with various aspects of the present disclosure.

FIG. 7 is a diagram illustrating an example vehicle in accordance with one or more techniques of this disclosure.

FIG. 8 is a diagram illustrating example processes for navigating an intersection with and without a time to intersection (TTI) calculation in accordance with one or more techniques of this disclosure.

FIG. 9 is a diagram illustrating example aspects pertaining to a TTI calculation in accordance with one or more techniques of this disclosure.

FIG. 10A is a diagram depicting an example of calculating a TTI and controlling a vehicle based on the TTI in accordance with one or more techniques of this disclosure.

FIG. 10B is a diagram depicting an example of calculating a TTI and controlling a vehicle based on the TTI in accordance with one or more techniques of this disclosure.

FIG. 10C is a diagram depicting an example of calculating a TTI and controlling a vehicle based on the TTI in accordance with one or more techniques of this disclosure.

FIG. 10D is a diagram depicting an example of calculating a TTI and controlling a vehicle based on the TTI in accordance with one or more techniques of this disclosure.

FIG. 11A is a diagram depicting an example of calculating a time to obstacle (TTO) and controlling a vehicle based on the TTO in accordance with one or more techniques of this disclosure.

FIG. 11B is a diagram depicting an example of calculating a TTO and controlling a vehicle based on the TTO in accordance with one or more techniques of this disclosure.

FIG. 11C is a diagram depicting an example of calculating a TTO and controlling a vehicle based on the TTO in accordance with one or more techniques of this disclosure.

FIG. 11D is a diagram depicting an example of calculating a TTO and controlling a vehicle based on the TTO in accordance with one or more techniques of this disclosure.

FIG. 12 is a communications flow diagram depicting example communications between a time to driving event (TTDE) component, sensors, and vehicle systems of a vehicle in accordance with one or more techniques of this disclosure.

FIG. 13 is a flowchart of a method of driving assistance in accordance with one or more techniques of this disclosure.

FIG. 14 is a flowchart of a method of driving assistance in accordance with one or more techniques of this disclosure.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

A vehicle may be equipped with a driver assistance system that enables the vehicle to operate autonomously or semi-autonomously from a person (i.e., a driver) in a driver's seat of the vehicle. For instance, when the vehicle approaches an intersection, the driver assistance system of the vehicle may identify the intersection based on sensor data and/or maps and determine whether the vehicle has a right-of-way (i.e., if a traffic light is green) at the intersection. If the vehicle has the right-of-way, the driver assistance system may cause the vehicle to drive through the intersection without input from the driver. If the vehicle does not have the right-of-way, the driver assistance system may cause the vehicle to stop at a stopping position (i.e., at a traffic marking before the traffic light) of the intersection without input from the driver. If the driver assistance system erroneously determines that the vehicle has the right-of-way (i.e., the traffic light is red and the driver assistance system identifies the traffic light as green) or if the driver assistance system erroneously determines that the vehicle does not have the right-of-way (i.e., the traffic light is green and the driver assistance system identifies the traffic light as red), the driver may take action causing the vehicle to stop at the stopping position or action causing the vehicle to drive through the intersection, respectively. The driver assistance system may visually indicate (e.g., on a display, such as a center console of the vehicle) an intent to proceed through an intersection or stop at the intersection to the driver; however, visual indications may be missed by the driver.

Various aspects relate generally to driver notifications during driving events. Some aspects more specifically relate to approaching an intersection or approaching an obstacle on a road. In some examples, an apparatus identifies that a vehicle is approaching a driving event based on sensor data while the vehicle is operating. The apparatus computes a time to arrival at the driving event based on the sensor data. The apparatus adjusts at least one of an acceleration value or a position (e.g., a lateral position) of the vehicle with respect to the driving event based on the sensor data and the time to arrival at the driving event being equal to a threshold value.

Particular aspects of the subject matter described in this disclosure can be implemented to realize one or more of the following potential advantages. In some examples, by adjusting at least one of the acceleration value or the position (e.g., a lateral position) of the vehicle with respect to the driving event when the time to arrival equals the threshold value, the apparatus may inform the driver of an intention of the vehicle with respect to the driving event (e.g., approaching an intersection) in a timely manner that enables the driver to take action if the driver so chooses. Furthermore, the apparatus may condition the driver over time to expect adjustment of the acceleration value and/or the position at a time instance at which the time to arrival equals the threshold value. Thus, the apparatus may provide the driver with the opportunity to determine whether the vehicle is performing in a suitable or desired manner and as such, the driver remains “in the loop” with respect to navigation decisions made by the vehicle.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

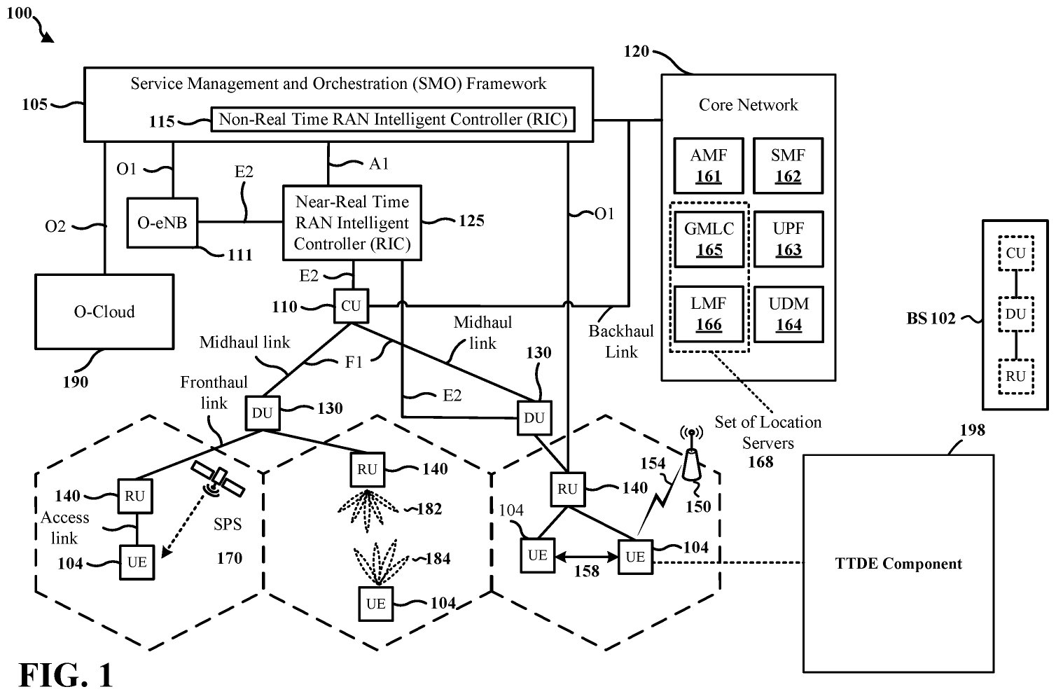

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-CNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2. FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a time to driving event (TTDE) component 198 that may be configured to identify that a vehicle is approaching a driving event based on sensor data while the vehicle is operating; compute a time to arrival at the driving event based on the sensor data; and adjust at least one of an acceleration value or a position (e.g., a lateral position) of the vehicle with respect to the driving event based on the sensor data and the time to arrival at the driving event being equal to a threshold value. Although the following description may focus on a time to an intersection or a time to an obstacle, the concepts described herein may be applicable to any driving scenario.

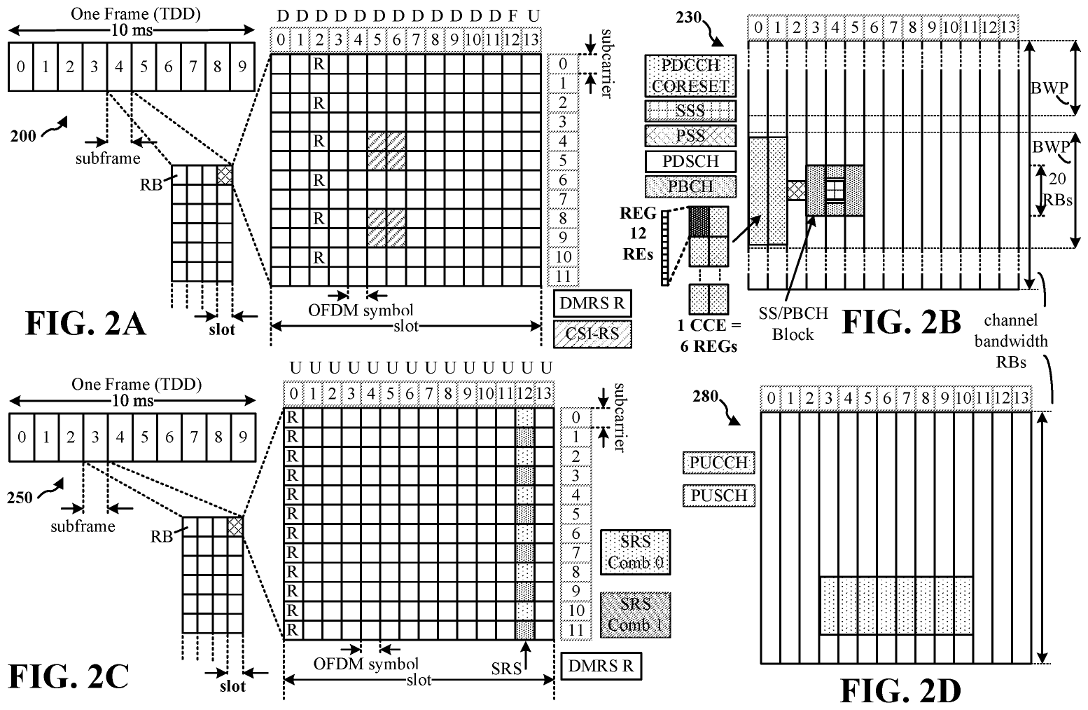

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2ª *15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

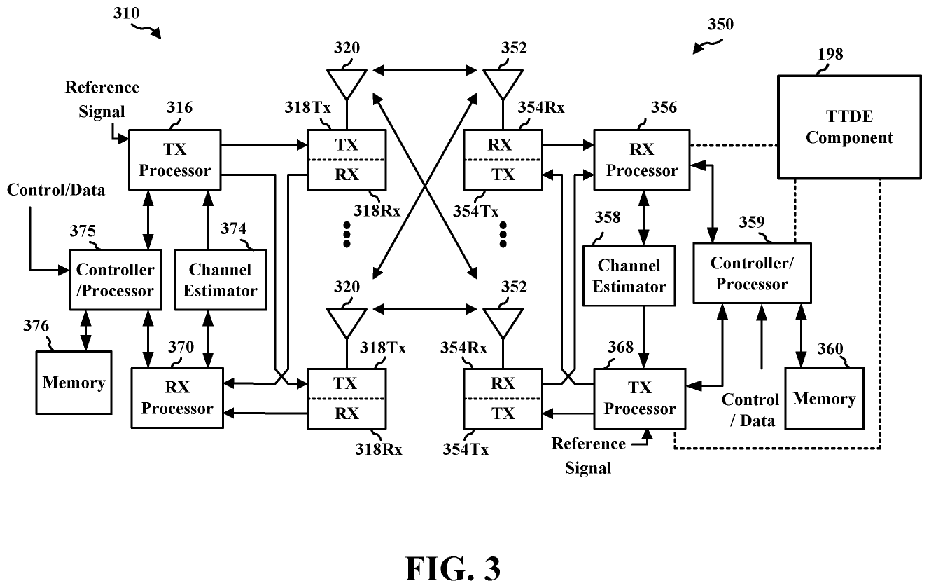

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions, Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the TTDE component 198 of FIG. 1.

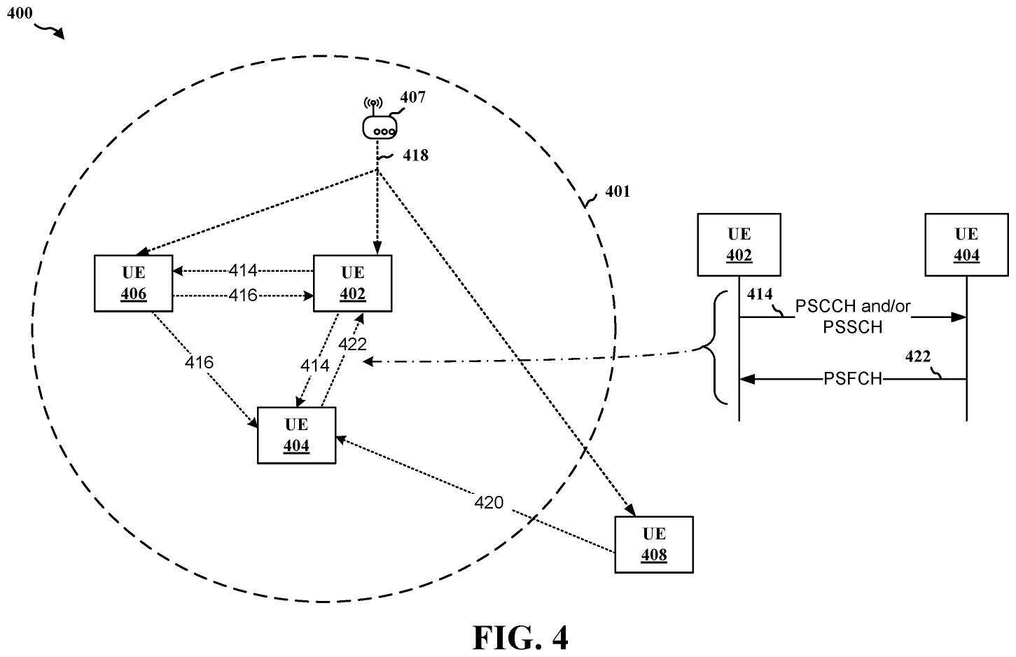

FIG. 4 is a diagram 400 illustrating an example of wireless communication between wireless devices based on sidelink (SL) communication in accordance with various aspects of the present disclosure. In one example, a UE 402 may transmit a transmission 414, e.g., including a control channel (e.g., a physical sidelink control channel (PSCCH)) and a corresponding data channel (e.g., a physical sidelink shared channel (PSSCH)), that may be received by one or more UEs (e.g., UEs 404 and 406). A control channel may include information for decoding the corresponding data channel, and it may also be used by a receiving UE for avoiding interference (e.g., UEs 404 and 406 may be refrained from transmitting data on resources occupied/reserved by the UE 402). For example, the UE 402 may indicate the number of transmission time intervals (TTIs) and the resource blocks (RBs) that are to be occupied by a transmission from the UE 402 in a control message (e.g., a sidelink control information (SCI) message). The UEs 402, 404, 406, and 408 may each have the capability to operate as a transmitting UE in addition to operating as a receiving UE. For example, UEs 404, 406, and 408 may also transmit transmissions 422, 416, and 420, respectively, to other UEs, such as the UEs 402 and 404. The transmissions 414, 416, 420 may be broadcast or multicast to nearby wireless devices or UEs. For example, the UE 402 may transmit communication (e.g., data) for receipt by other UEs within a range 401 of the UE 402. Additionally, or alternatively, a road side unit (RSU) 407 may be used to provide connectivity and information to sidelink devices, such as by receiving communication from and/or transmitting communication (e.g., communication 418) to UEs 402, 406, and 408.

Sidelink communication that is exchanged directly between UEs (which may be referred to as “sidelink UEs” hereafter) may include discovery messages for a UE to find other nearby UEs. In some examples, the sidelink communication may also include resource reservation information associated with other sidelink UEs, which may be used by a UE for determining/selecting the resources for transmission.

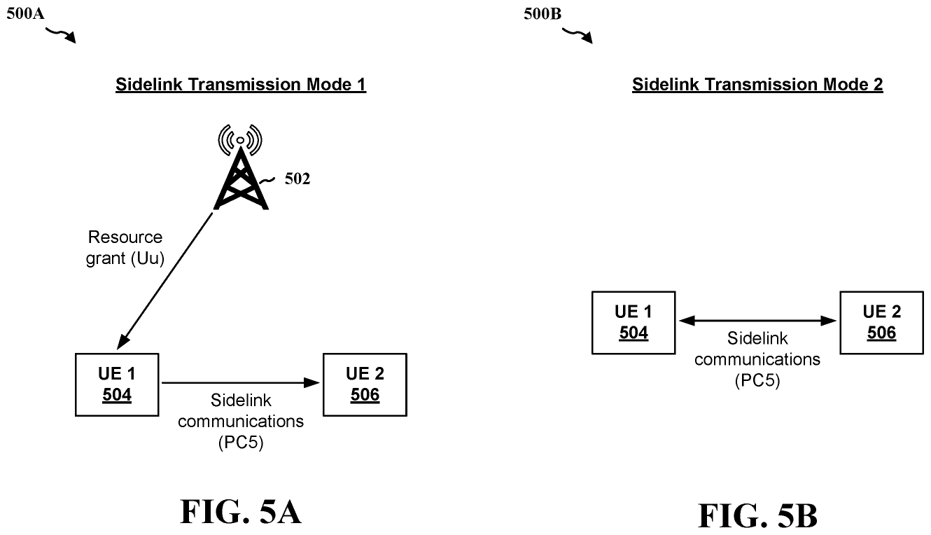

In one example, a sidelink communication may be based on different types or modes of resource allocation mechanisms. As shown by a diagram 500A of FIG. 5A, in a first resource allocation mode (which may be referred to as “Mode 1,” “sidelink transmission Mode 1,” and/or “V2X Mode 1,” etc.), a centralized resource allocation may be provided. For example, under the first resource allocation mode, a base station 502 may determine and allocate sidelink resources for communications between a first UE 504 and a second UE 506. The first UE 504 may receive an indication of the allocated sidelink resources (e.g., a resource grant) from the base station 502 via a UE-to-universal mobile telecommunications system (UMTS) terrestrial radio access network (UE-to-UTRAN) (Uu) link (e.g., via a resource radio control (RRC) message or downlink control information (DCI) (e.g., DCI format 3_0)), and then the first UE 504 may use the allocated sidelink resources for communicating with the second UE 506 over the sidelink (which may also be referred to as a PC5 link).

As shown by a diagram 500B of FIG. 5B, in a second resource allocation mode (which may be referred to as “Mode 2,” “sidelink transmission Mode 2,” and/or “V2X Mode 2,” etc.), a distributed resource allocation may be provided between UEs. For example, under the second resource allocation mode, each UE may autonomously determine sidelink resources for its sidelink transmission. In order to coordinate the selection of sidelink resources by individual UEs, each UE may use a sensing technique to monitor/detect sidelink resources reserved/used by other UEs, and then each UE may select sidelink resources for its sidelink transmissions from unreserved/used sidelink resources. For example, a first UE 504 may sense and select unreserved/unused sidelink resources in a sidelink resource pool based on decoding SCI messages received (e.g., transmitted from a second UE 506 or another UE), and the first UE 504 may use the selected side resources for communicating with the second UE 506. After the first UE 504 selects the sidelink resources for its transmission, the first UE 504 may also transmit/broadcast (e.g., via groupcast or broadcast) to other UEs the sidelink resources used/reserved by the first UE 504 via SCI, such that other UEs may refrain using these sidelink resources to avoid resource collision (e.g., two UEs transmitting simultaneously using same time and frequency resources). Signaling on sidelink may be the same between the two resource allocation modes (e.g., Mode 1 and Mode 2). For example, from a receiving UE's point of view (e.g., the second UE 506), there may be no difference between the two resource allocation modes.

In some examples, a UE receiving a sidelink transmission (which may be referred to as a receiving UE) may be configured to provide feedback (e.g., an acknowledgement (ACK) or a negative acknowledgement (NACK)) to a UE transmitting the sidelink transmission (which may be referred to as a transmitting UE). For example, after the second UE 506 receives a transmission from the first UE 504, the second UE 506 may send an ACK to the first UE 504 via a physical sidelink feedback channel (PSFCH) if the second UE 506 is able to receive and decode the transmission. On the other hand, if the second UE 506 is unable to decode or receive the transmission, the second UE 506 may send a NACK to the first UE 504. In one example, if the transmission from the first UE 504 is a unicast or a groupcast message, the second UE 506 may be configured to transmit an explicit ACK/NACK to the first UE 504 indicating whether the transmission is successfully decoded, e.g., the second UE 506 transmits an ACK if the transmission is successfully decoded and transmits a NACK if the transmission is not successfully decoded. In another example, if the transmission from the first UE 504 is a groupcast message, the second UE 506 may be configured to transmit an implicit NACK, where the second UE 506 may transmit a NACK to the first UE 504 if the second UE 506 is unable to decode or does not receive the transmission. However, the second UE 506 may skip transmitting an ACK if the second UE 506 successfully decodes the transmission.

Sidelink communications may take place in transmission or reception sidelink resource pools. The minimum resource allocation unit in a sidelink resource pool may be a sub-channel in frequency, and the resource allocation in time may be one slot. Some slots in a sidelink resource pool may are not be available for sidelink communications (e.g., may be reserved/configured for other purposes or other types of communications). For example, some slots may contain feedback resources (e.g., a PSFCH). A base station may configure a sidelink resource pool to a set of UEs, such as via an RRC configuration, or the sidelink resource pool may be preloaded on the set of UEs (e.g., via a pre-configuration).

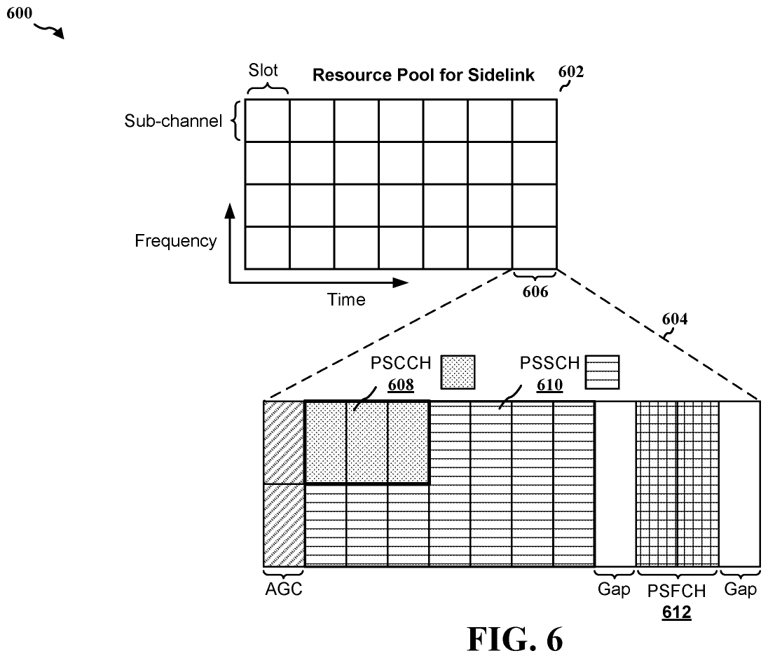

FIG. 6 is a diagram 600 illustrating an example structure of a sidelink resource pool in accordance with various aspects of the present disclosure. A sidelink resource pool 602 may include a set of time and frequency resources (e.g., each slot and sub-channel may indicate a time and frequency resource), and each time and frequency resource may be used by a transmitting UE for transmitting a PSCCH and/or a PSSCH, or used by a receiving UE for transmitting a PSFCH. For example, as shown at 604, a slot 606 may include resources for a PSCCH 608, a PSSCH 610, and a PSFCH 612. After a receiving UE receives the slot 606 (e.g., the second UE 506), the receiving UE may first decode the SCI in the PSCCH 608 and/or the PSSCH 610 (e.g., for a two-stage SCI), then decode data in the PSSCH 610. The receiving UE may also receive a feedback via the PSFCH 612 (e.g., for a previous transmission to the transmitting UE), or the receiving UE may also transmit a feedback for the PSSCH 610 via the PSFCH 612.

A vehicle may be equipped with a driver assistance system that enables the vehicle to operate autonomously or semi-autonomously from a person (i.e., a driver) in a driver's seat of the vehicle. For instance, when the vehicle approaches an intersection, the driver assistance system of the vehicle may identify the intersection based on sensor data and/or maps and determine whether the vehicle has a right-of-way (i.e., if a traffic light is green) at the intersection. If the vehicle has the right-of-way, the driver assistance system may cause the vehicle to drive through the intersection without input from the driver. If the vehicle does not have the right-of-way, the driver assistance system may cause the vehicle to stop at a stopping position (i.e., at a traffic marking before the traffic light) of the intersection without input from the driver.

If the driver assistance system erroneously determines that the vehicle has the right-of-way (i.e., the traffic light is red and the driver assistance system identifies the traffic light as green) or if the driver assistance system erroneously determines that the vehicle does not have the right-of-way (i.e., the traffic light is green and the driver assistance system identifies the traffic light as red), the driver may take action causing the vehicle to stop at the stopping position or action causing the vehicle to drive through the intersection, respectively. The driver assistance system may visually indicate (e.g., on a display, such as a center console of the vehicle) an intent to proceed through an intersection or stop at the intersection to the driver; however, visual indications may be missed by the driver.

Various technologies pertaining to driver notifications during driving events are described herein. In an example, an apparatus identifies that a vehicle is approaching a driving event based on sensor data while the vehicle is operating. The apparatus computes a time to arrival at the driving event based on the sensor data. The apparatus adjusts at least one of an acceleration value or a position (e.g., a lateral position) of the vehicle with respect to the driving event based on the sensor data and the time to arrival at the driving event being equal to a threshold value. Vis-à-vis adjusting at least one of the acceleration value or the position of the vehicle with respect to the driving event when the time to arrival equals the threshold value, the apparatus may inform the driver of an intention of the vehicle with respect to the driving event (e.g., approaching an intersection) in a timely manner that enables the driver to take action if the driver so chooses. Furthermore, the apparatus may condition the driver over time to expect adjustment of the acceleration value and/or the position (e.g., a lateral position) at a time instance at which the time to arrival equals the threshold value. Thus, the apparatus may provide the driver with the opportunity to determine whether the vehicle is performing in a suitable or desired manner and as such, the driver remains “in the loop” with respect to navigation decisions made by the vehicle.

In one aspect, at a time to intersection (TTI), a driver may be informed of a vehicle's intended action at an upcoming traffic signaled intersection, so that the driver may intervene if they wish to do so; where the TTI may be pre-configured, and where the vehicle may accelerate/decelerate so that the information is provided to the driver at the configured TTI. In an embodiment, the vehicle's intended action may be based on the traffic signal being red (intended action=stop) or green (intended action=go). In an example, when the traffic signal is red, the information regarding the vehicle's intended action may be provided to the driver in the form of a deceleration jerk or the vehicle slowing down. In an embodiment when the traffic signal is green, the information regarding the vehicle's intended action may be provided to the driver in the form of an acceleration jerk or sound or vibration.

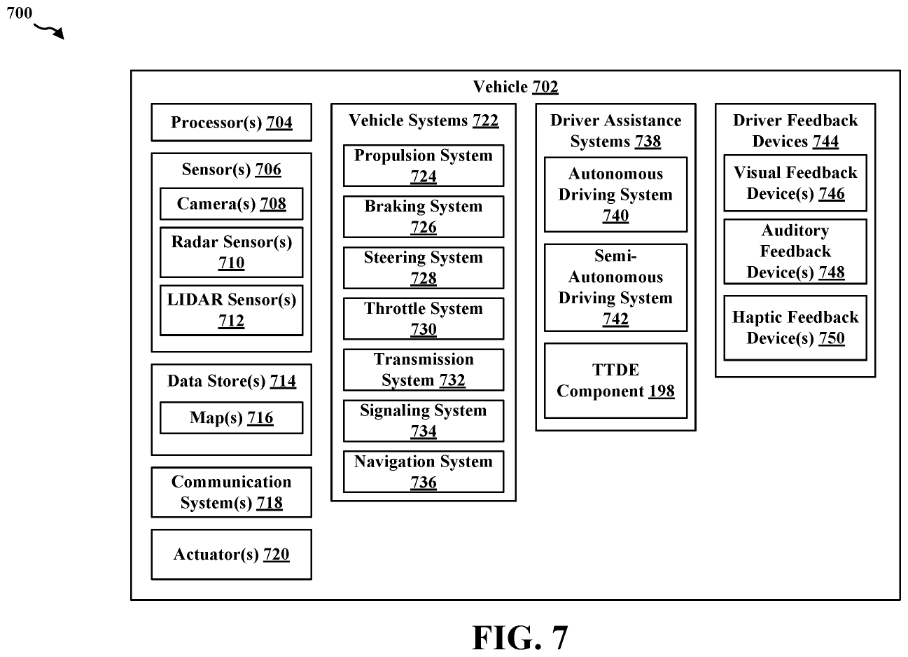

FIG. 7 is a diagram 700 illustrating an example vehicle 702 according to one or more techniques of this disclosure. In an example, the vehicle 702 may be a car, a bus, a motorcycle, etc. The vehicle 702 may include processor(s) 704. The vehicle 702 may include sensor(s) 706 that may enable the vehicle 702 to perceive an environment around the vehicle 702. The sensor(s) 706 may include camera(s) 708, radar sensor(s) 710, and/or light detection and ranging (LIDAR) sensor(s) 712 (which may also be referred to as “laser imaging, detection, and ranging sensors”). The vehicle 702 may include data store(s) 714. The data store(s) 714 may include map(s) 716 that may facilitate navigation of the vehicle 702 through environments. The map(s) 716 may include standard-definition (SD) maps and high-definition (HD) maps. SD maps may have approximately meter-level accuracy and HD maps may have approximately centimeter-level accuracy.

The vehicle 702 may include communication system(s) 718 that may enable the vehicle to communicate with other devices, such as other vehicles, remote servers, road-side units (RSUs), onboard units (OBUs), mobile phones, etc. The communication system(s) 718 may include vehicle-to-vehicle (V2V) communication systems and vehicle-to-everything (V2X) communication systems. The communication system(s) 718 may include transceivers and/or antennas. The communication system(s) 718 may include wireless local area network (WLAN) systems, Bluetooth communication systems, and/or wireless communication systems such as 5G New Radio (NR), Long-Term Evolution (LTE), etc.

The vehicle 702 may include actuator(s) 720. The actuator(s) 720 may include one or more elements that may change other elements of the vehicle 702 based on signals from the processor(s) 704 or other inputs. The actuator(s) 720 may include motors, relays, hydraulic pistons, pneumatic actuators, etc.

The vehicle 702 may include vehicle systems 722 that facilitate movement of the vehicle 702. The vehicle systems 722 may include a propulsion system 724 that converts energy into force used to turn wheels of the vehicle 702. The propulsion system 724 may include an internal combustion engine and/or an electric engine. The propulsion system 724 may also be used to power functions of the vehicle 702 not related to movement of the vehicle 702. The vehicle systems 722 may include a braking system 726 that enables the vehicle 702 to brake. The vehicle systems 722 may include a steering system 728 that enables the vehicle 702 to change directions (i.e., steer). The vehicle systems 722 may include a throttle system 730 that enables the vehicle 702 to control a flow of fuel or power to an engine of the vehicle 702. The vehicle 702 may include a transmission system 732 that may change a speed or a direction of rotation of a mechanical device. The vehicle systems 722 may include a signaling system 734 that enables the vehicle to output indications to devices and persons that signal an intent of the vehicle. The signaling system 734 may include turn-signals, blinkers, headlights, etc. The vehicle 702 may include a navigation system 736 that facilitates navigation of the vehicle 702 about an environment. The navigation system 736 may utilize inputs from the sensor(s) 706, the map(s) 716, and/or the communication system(s) 718 in order to generate a route that the vehicle 702 may navigate. The navigation system 736 may be or include a global navigation satellite system (GNSS), such as a global positioning system (GPS).

The vehicle 702 may include driver assistance systems 738 that aid a driver of the vehicle 702 when the vehicle 702 is operated. The driver assistance systems 738 may include an autonomous driving system 740 that enables the vehicle 702 to operate (i.e., navigate about an environment) autonomously without input from the driver. The driver assistance systems 738 may include a semi-autonomous driving system 742 that enables the vehicle 702 to operate semi-autonomously (i.e., both the driver and the vehicle 702 may share responsibilities for operating the vehicle). The driver assistance systems 738 may include a time to driving event (TTDE) component 198. As will be described in greater detail below, the TTDE component 198 may be configured to compute a TTDE based on sensor data generated by the sensor(s) 706 and/or data from the map(s) and the TTDE component 198 may be configured to change an acceleration value and/or a position of the vehicle 702 based on the TTDE. The TTDE component 198 may be implemented in hardware and/or software.

The vehicle 702 may include driver feedback devices 744 that provide feedback to the driver as the vehicle 702 operates. The driver feedback devices 744 may include visual feedback device(s) 746 that provide visual feedback to a user. The visual feedback device(s) may include a display panel. The driver feedback devices 744 may include auditory feedback device(s) 748 that provide auditory feedback to the driver. The auditory feedback device(s) 748 may include speaker(s). The vehicle 702 may include haptic feedback device(s) 750 that provide haptic feedback to the driver. The haptic feedback device(s) 750 may include motor(s).

The vehicle 702 may also include components in addition to those depicted in the diagram 700, such as memory storing instructions, seating, wheels, a steering wheel, microphones, etc.

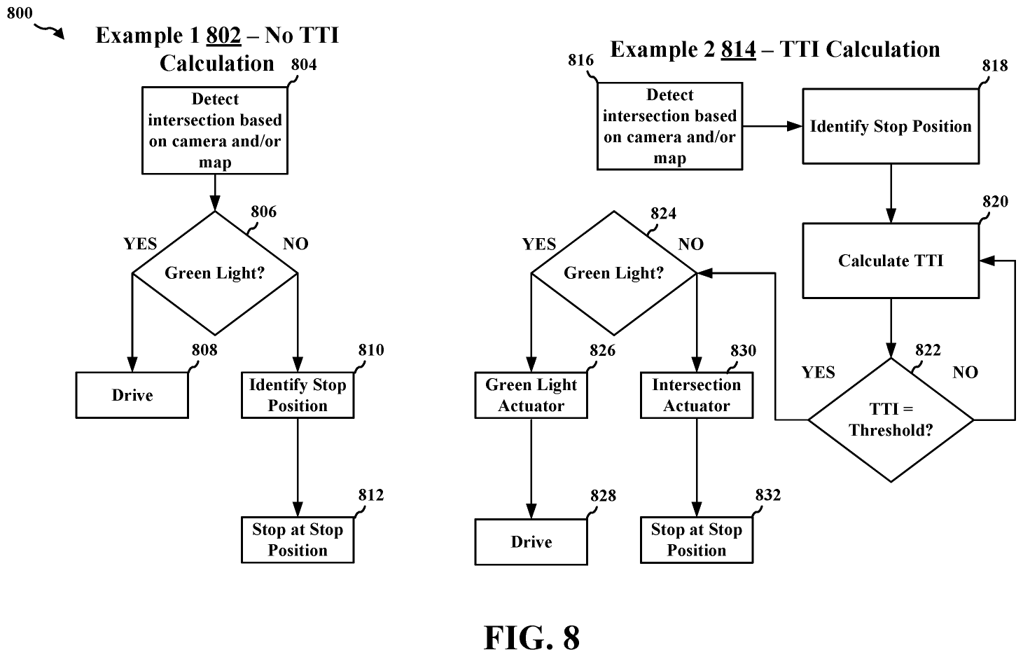

FIG. 8 is a diagram 800 illustrating example processes for navigating an intersection with and without a time to intersection (TTI) calculation. As used herein, the term “TTI” may refer to a time computed by a vehicle (or a component thereof) for the vehicle to move from a first position to a second position, where the first position is a current position of the vehicle and where the second position is a road marking (e.g., a stop line) where vehicles are to stop prior to entering an intersection when the vehicle does not have a right-of-way (e.g., when a traffic light at the intersection is red) to proceed through the intersection.

In a first example 802, a vehicle (e.g., the vehicle 702) may not calculate a TTI. The vehicle may be operating in an autonomous mode or a semi-autonomous mode. At 804, the vehicle may detect that the vehicle is approaching an intersection based on sensor data, such as image(s) captured by camera(s), and/or data from map(s). At 806, the vehicle may determine whether a traffic light at the intersection is green (i.e., whether the vehicle has a right-of-way with respect to the intersection) based on the sensor data. At 808, upon positive determination, the vehicle may proceed through the intersection (i.e., the vehicle may drive through the intersection). For instance, the vehicle may control vehicle systems of the vehicle such that the vehicle accelerates through the intersection, maintains a current acceleration while proceeding through the intersection, or decelerates through the intersection (without coming to a stop). At 810, upon negative determination, the vehicle may identify a stop position (e.g., a traffic marking on the ground indicating where the vehicle is to stop if the vehicle does not have the right-of-way) with respect to the intersection based on the sensor data. At 812, the vehicle may stop at the identified stop position. For instance, the vehicle may control the vehicle systems of the vehicle such that the vehicle decelerates and comes to a stop at the stop position. The driving scenario described above in the first example 802 may not inform a driver of the vehicle of an intent of the vehicle to proceed or not proceed through the intersection in a timely manner.

In a second example 814, the vehicle (e.g., the vehicle 702) may calculate a TTI. The vehicle may be operating in an autonomous mode or a semi-autonomous mode. At 816, the vehicle may detect that the vehicle is approaching an intersection based on sensor data, such as image(s) captured by camera(s), and/or data from map(s). At 818, the vehicle may identify a stop position (e.g., a traffic marking on the ground indicating where the vehicle is to stop if the vehicle does not have the right-of-way) with respect to the intersection based on the sensor data. At 820, the vehicle may calculate a TTI based on the sensor data. For instance, the vehicle may determine a current position of the vehicle based on the sensor data, a current velocity of the vehicle, and a current acceleration of the vehicle. The vehicle may compute the TTI based on the current position of the vehicle, the stop position, the current velocity of the vehicle, and the current acceleration of the vehicle. At 822, the vehicle may determine whether the TTI is equal to a threshold value (i.e., a threshold time value). In one aspect, the threshold value may be a global value for a plurality of driving scenarios. Upon negative determination, the vehicle may repeat the TTI calculation at 820 using updated values for the current position of the vehicle, the stop position of the vehicle, the velocity of the vehicle, and the current acceleration of the vehicle. For instance, the vehicle may calculate the TTI as described above at periodic intervals.

Upon positive determination, at 824, the vehicle may determine whether a traffic light at the intersection is green (i.e., whether the vehicle has a right-of-way with respect to the intersection) based on the sensor data. Additionally, or alternatively, in some aspects, at 824, the vehicle may determine whether the vehicle has the right-of-way with respect to the intersection based on received vehicle to infrastructure (V21) data that indicates whether or not the vehicle has the right-of-way with respect to the intersection. Upon positive determination, and at a time instance at which the TTI equals the threshold value, at 826, the vehicle may implement green light actuator behavior. In one example with respect to the green light actuator behavior, the vehicle may increase an acceleration value of the vehicle at the time instance. In another example with respect to the green light actuator behavior, the vehicle may maintain a current acceleration (and hence a current velocity) at the time instance. Stated differently, through the green light actuator behavior, the vehicle may inform the driver at the time instance that the vehicle has identified the intersection and that the vehicle intends to proceed through the intersection. At 828, the vehicle may proceed through the intersection based on the green light actuator behavior.

Upon negative determination, and at the time instance at which the TTI equals the threshold value, at 830, the vehicle may implement intersection actuator behavior. In an example, the vehicle may decrease an acceleration value of the vehicle at the time instance at which the TTI equals the threshold value. Stated differently, through the intersection actuator behavior, the vehicle may inform the driver at the time instance that the vehicle has identified the intersection and that the vehicle intends to stop at the intersection. At 832, the vehicle may stop at the identified stop position based on the intersection actuator behavior.

The second example 814 described above (TTI calculation) may be associated with various advantages compared to the first example 802 (no TTI calculation) described above. By implementing the green light actuator behavior or the intersection actuator behavior at the time instance at which the TTI equals the threshold value, the vehicle may inform the driver of an intention of the vehicle with respect to the intersection in a timely manner that enables the driver to take action if the driver so chooses. In an example, if a driver assistance system (e.g., the autonomous driving system, the semi-autonomous driving system 742, etc.) misidentifies a traffic signal (e.g., misidentifies a green light for a red light or vice versa), the vehicle may inform the driver of an intention of the vehicle (e.g., via the green light actuator behavior or the intersection actuator behavior) at the time instance at which the TTI equals the threshold value such that the driver has an opportunity recognize the misidentification and take corrective action before the vehicle reaches the intersection. For example, the intended behavior of the vehicle may be overridden by the driver (e.g., by accelerating or decelerating the vehicle, changing a position of the vehicle, etc.). Furthermore, the driver may become conditioned over time to expect the green light actuator behavior or the intersection actuator behavior at the time instance at which the TTI equals the threshold value. Thus, the driver may be given the opportunity to determine whether the vehicle is performing in a suitable manner and as such, the driver remains “in the loop” with respect to navigation decisions made by the vehicle.

In one aspect, the vehicle may identify a color and/or a symbol on a traffic signal at the intersection. The vehicle may predict whether the color and/or a symbol on the traffic signal at the intersection. For example, the vehicle may predict whether color and/or the symbol on the traffic signal will change based on an amount of time that the color and/or the symbol has remained constant and/or based on data about behavior of the traffic signal at the intersection. At a time instance at which the TTI is equal to the threshold value, the vehicle may adjust an acceleration value (e.g., implement the green light actuator behavior or the intersection actuator behavior) and/or a position (e.g., a lateral position) of the vehicle based on the prediction. For instance, if the traffic signal is red at the time instance, but the traffic signal is predicted to change from red to green within a relatively short period of time (e.g., a few milliseconds) after the time instance, the vehicle may implement the green light actuator behavior at the time instance.

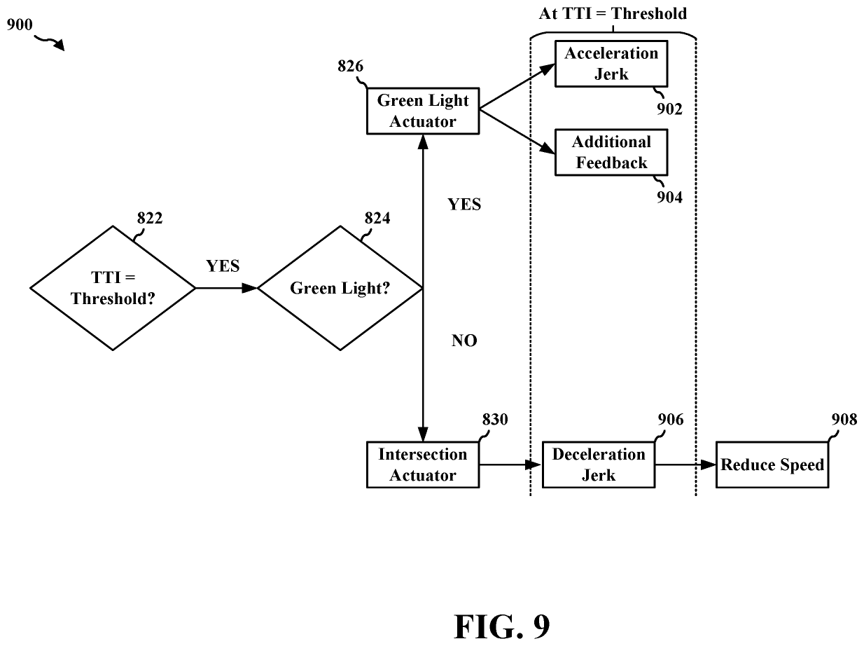

FIG. 9 is a diagram 900 illustrating example aspects pertaining to a TTI calculation in accordance with one or more techniques of this disclosure. The green light actuator behavior implemented by the vehicle at the time instance at which the TTI equals the threshold value may include, at 902, the vehicle controlling the vehicle systems to produce an acceleration jerk at the time instance. The acceleration jerk may refer to a positive change in a rate of acceleration of the vehicle. Furthermore, the green light actuator behavior may include, at 904, additional feedback. The additional feedback may include generating a sound (i.e., auditory feedback) corresponding to an acceleration or an acceleration jerk at the time instance. The additional feedback may include generating a vibration (i.e., haptic feedback) in a seat, wheel, or floor of the vehicle corresponding to the acceleration or the acceleration jerk at the time instance. The additional feedback may include generating visual information (i.e., visual feedback) at the time instance that informs the driver that the vehicle intends to proceed through the intersection.

The intersection actuator behavior implemented by the vehicle at the time instance at which the TTI equals the threshold value may include, at 906, the vehicle controlling the vehicle systems to produce a deceleration jerk. The deceleration jerk may refer to a negative change in a rate of acceleration of the vehicle. The intersection actuator behavior may also include generating auditory, haptic, and/or visual feedback at the time instance corresponding to the deceleration jerk. At 908, the intersection actuator behavior may include reducing a speed of the vehicle in order for the vehicle to stop at a stop position of the intersection.

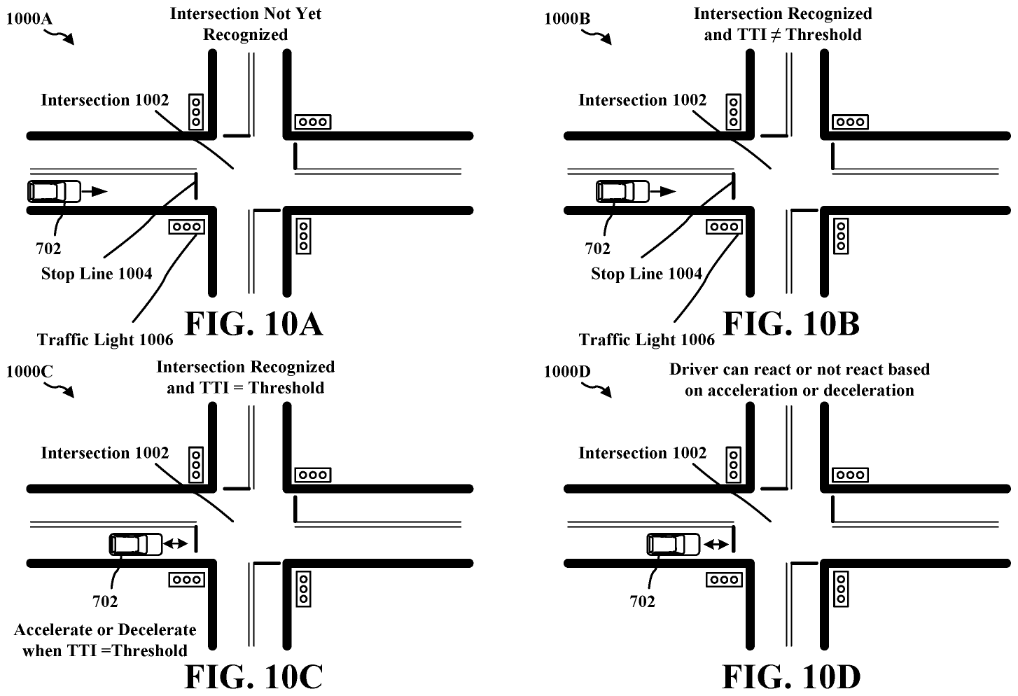

FIGS. 10A-10D are diagrams 1000A, 1000B, 1000C, and 1000D depicting examples of the vehicle 702 calculating a TTI and controlling the vehicle 702 based on the calculated TTI. In the diagrams 1000A-400D, the vehicle 702 may be operating in an autonomous mode or a semi-autonomous mode. The examples depicted in the diagrams 1000A-1000D may correspond to the aspects described above in the description of FIGS. 8 and 9.

Referring to FIG. 10A, the vehicle 702 may be travelling cast on a road in an autonomous driving mode or a semi-autonomous driving mode. The road may be part of an intersection 1002 (e.g., a location where at least two roads meet), where the intersection 1002 may have a stop line 1004 and a traffic light 1006. In the example depicted in the diagram 1000A, the vehicle 702 has not yet identified the intersection 1002.

Referring to FIG. 10B, the vehicle 702 has travelled further east (and is closer to the intersection 1002 compared to the example depicted in the diagram 1000A). The vehicle 702 may identify the intersection 1002 and the stop line 1004 of the intersection 1002 based on sensor data generated by the sensor(s) 706 of the vehicle 702. The vehicle 702 may calculate a TTI as described above. However, in the example depicted in the diagram 1000B, the TTI calculated by the vehicle 702 may not be equal to the threshold value.

Referring to FIG. 10C, the vehicle 702 has travelled further east (and is closer to the intersection 1002 compared to the example depicted in the diagram 1000B). In the example depicted in the diagram 1000C, the vehicle 702 may determine that the TTI is equal to the threshold value. Upon determining that the TTI is equal to the threshold value, the vehicle 702 may determine whether the traffic light 1006 is green (i.e., whether the vehicle 702 has the right-of-way with respect to the intersection 1002) based on sensor data generated by the sensor(s) 706. Based on the determination, the vehicle 702 may implement the green light actuator behavior or the intersection actuator behavior at a time instance in which the TTI is equal to the threshold value as described above in the description of FIGS. 8 and 9. Although the identification of the intersection 1002 and the determination that the TTI equals the threshold value are described above as occurring consecutively, the identification of the intersection 1002 and the determination that the TTI equals the threshold value may be performed concurrently.

Referring to FIG. 10D, the driver of the vehicle 702 may perceive the green light actuator behavior or the intersection actuator behavior at the time instance. The driver may then react or not react based on perceiving the green light actuator behavior or the intersection actuator behavior at the time instance. For example, if the driver does not react, the vehicle 702 may continue with its intended behavior (e.g., stopping at the stop line 1004 or proceeding through the intersection 1002). For example, if the driver does react, the driver may override the intended behavior of the vehicle 702 as perceived by the driver through the green light actuator behavior or the intersection actuator behavior. Based on the foregoing, the driver may be conditioned over time to expect a cue (e.g., the green light actuator behavior, the intersection actuator behavior) at a time instance at which the TTI is equal to the threshold. For instance, if the vehicle 702 does not recognize the intersection 1002 (e.g., due to a sensor obstruction) and hence does not produce the cue, the driver may respond to the lack of the cue (e.g., by braking or accelerating) due to the conditioning.

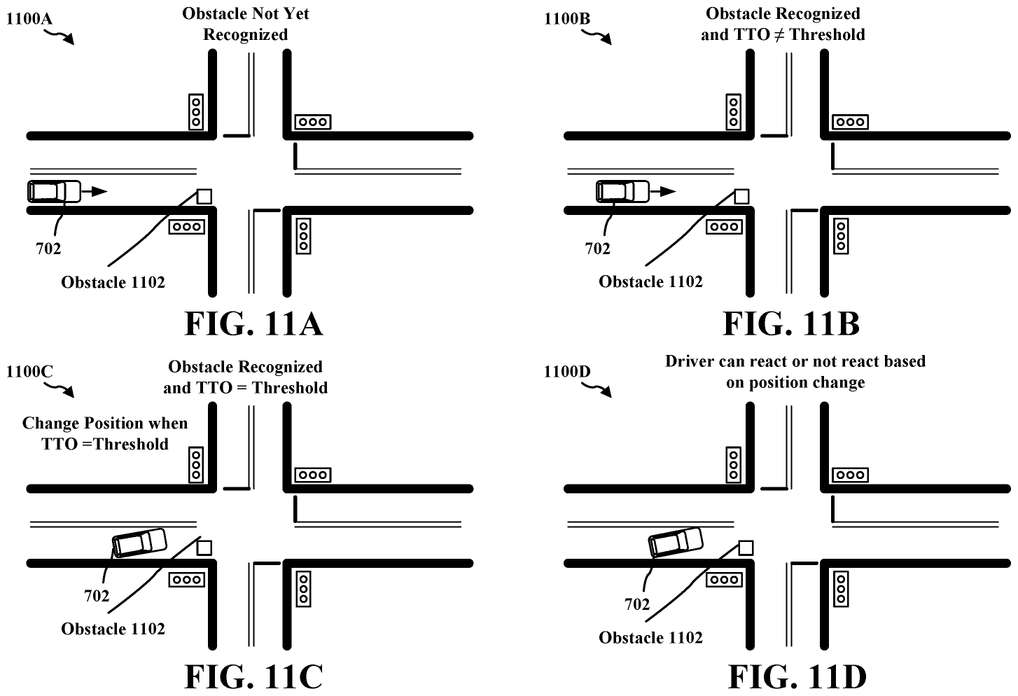

FIGS. 11A-11D are diagrams 1100A, 1100B, 1100C, and 1100D depicting example illustrations of the vehicle 702 calculating a time to obstacle (TTO) and controlling the vehicle 702 based on the calculated TTI. Although the concepts described above in the description of FIGS. 8, 9, and 10A-10D relate to an intersection, such concepts may also be utilized in other driving scenarios, such as a driving scenario in which the vehicle 702 encounters an obstacle on a road. As used herein, the term “TTO” may refer to a time computed by a vehicle (or a component thereof) for the vehicle to move from a first position to a second position, where the first position is a current position of the vehicle and where the second position is a position of an obstacle. In the diagrams 1100A-110D, the vehicle 702 may be operating in an autonomous mode or a semi-autonomous mode. The examples depicted in the diagrams 1100A-1100D may correspond to aspects described above in the description of FIGS. 8, 9, and 10A-10D.

Referring to FIG. 11A, the vehicle 702 may be travelling cast on a road in an autonomous driving mode or a semi-autonomous driving mode. An obstacle 1102 may be present on the road. In an example, the obstacle 1102 may be debris, a road sign, a pedestrian, a vehicle, a cyclist, etc. In the example depicted in the diagram 1100A, the vehicle 702 has not yet identified the obstacle 1102.

Referring to FIG. 11B, the vehicle 702 has travelled further cast (and is closer to the obstacle 1102 compared to the example depicted in the diagram 1100A). The vehicle 702 may identify the obstacle 1102 based on sensor data generated by the sensor(s) 706 of the vehicle 702. The vehicle 702 may calculate a TTO as described above in a manner similar to that described above with respect to the TTI. For instance, the vehicle 702 may calculate the TTO based on a current position of the vehicle 702 (as ascertained through the sensor data), a position of the obstacle 1102 (as ascertained through the sensor data), a current velocity of the vehicle 702 (as ascertained through the sensor data), and a current acceleration of the vehicle 702 (as ascertained through the sensor data). However, in the example depicted in the diagram 1000B, the TTO calculated by the vehicle 702 may not be equal to the threshold value.

Referring to FIG. 11C, the vehicle 702 has travelled further east (and is closer to the obstacle 1102 compared to the example depicted in the diagram 1100B). In the example depicted in the diagram 1100C, the vehicle 702 may determine that the TTO is equal to the threshold value. Based on the determination, the vehicle 702 may implement behavior similar to the green light actuator behavior or the intersection actuator behavior at a time instance in which the TTO is equal to the threshold value as described above in the description of FIGS. 8 and 9. For instance, the vehicle 702 may control the vehicle systems 722 to change an acceleration value of the vehicle 702 at the time instance. Additionally, or alternatively, the vehicle 702 may control the vehicle systems 722 to change a position of the vehicle with respect to the obstacle 1102 at the time instance. Although the identification of the obstacle 1102 and the determination that the TTO equals the threshold value are described above as occurring consecutively, the identification of the obstacle 1102 and the determination that the TTO equals the threshold value may be performed concurrently.

Referring to FIG. 11D, the driver of the vehicle 702 may perceive the behavior similar to the green light actuator behavior or the intersection actuator behavior at the time instance. The driver may then react or not react based on perceiving the behavior similar to the green light actuator behavior or the intersection actuator behavior at the time instance. For example, if the driver does not react, the vehicle 702 may continue with its intended behavior. For example, if the driver does react, the driver may override the intended behavior of the vehicle 702 as perceived by the driver through the behavior similar to the green light actuator behavior or the intersection actuator behavior. Based on the foregoing, the driver may be conditioned over time to expect a cue (e.g., the green light actuator behavior, the intersection actuator behavior) at a time instance at which the TTO is equal to the threshold. For instance, if the vehicle 702 does not recognize the obstacle 1102 (e.g., due to a sensor obstruction) and hence does not produce the cue, the driver may respond to the lack of the cue (e.g., by braking or accelerating, changing a position of the vehicle with respect to the obstacle 1102, etc.) due to the conditioning.

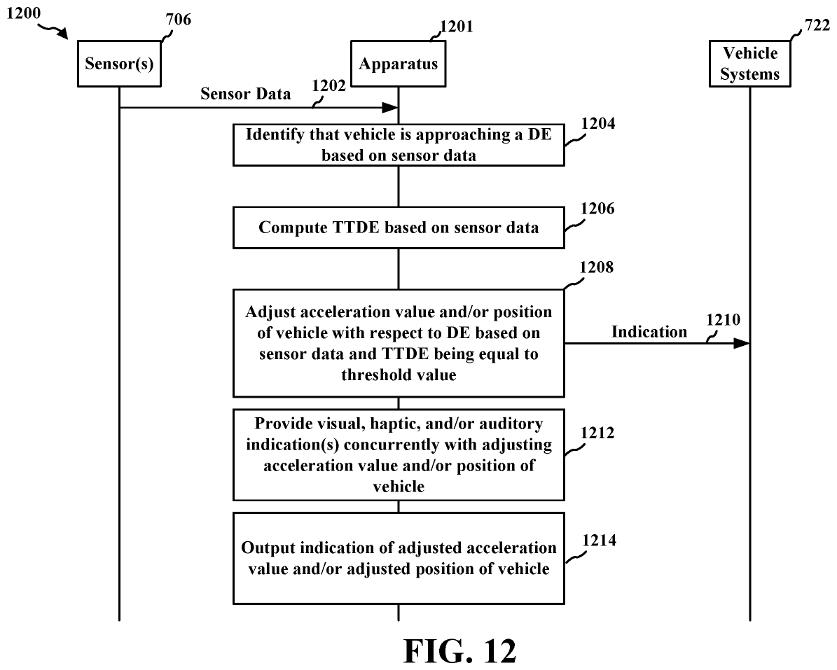

FIG. 12 is a communications flow diagram 1200 depicting example communications between the apparatus 1201, the sensor(s) 706, and the vehicle systems 722 of the vehicle 702. As used herein, the term “driving event” (DE) may refer to a scenario in which a vehicle approaches an intersection, a scenario in which a vehicle approaches an obstacle, or another driving scenario. As used herein, the term “TTDE” may refer to a time computed by a vehicle (or a component thereof) for the vehicle to move from a first position to a second position, where the first position is a current position of the vehicle and where the second position is a position associated with the driving event. The term TTDE may also be referred to as a “time to arrival at a driving event.”

At 1202, the apparatus 1201 may obtain (e.g., receive) sensor data generated by the sensor(s) 706. The sensor data may include image(s) captured by the camera(s) 708, radar data generated by the radar sensor(s) 710, and/or LIDAR data generated by the LIDAR sensor(s) 712. The sensor data may also include a current position of the vehicle 702, a velocity of the vehicle 702, and/or an acceleration value of the vehicle 702. The vehicle 702 may be operating in a self-driving mode or a driver-assisted mode. At 1204, the apparatus 1201 may identify that the vehicle 702 is approaching a driving event based on the sensor data. Additionally, the apparatus 1201 may identify that the vehicle 702 is approaching the driving event based on data from the map(s) 716. At 1206, the apparatus 1201 may compute a TTDE based on the sensor data. The apparatus 1201 may also compute the TTDE based on the data from the map.

At 1208, the apparatus 1201 may adjust an acceleration value and/or a position (e.g., a lateral position) of the vehicle 702 with respect to the driving event based on the sensor data and the TTDE being equal to a threshold value. For instance, at 1210, the apparatus 1201 may transmit an indication of the acceleration value and/or the position of the vehicle 702 with respect to the driving event to the vehicle systems 722, where the vehicle systems 722 may act to adjust the acceleration value and/or the (e.g., a lateral position) position of the vehicle 702 with respect to the driving event. At 1212, the apparatus 1201 may provide visual indication(s), haptic indication(s), and/or auditory indication(s) to a driver of the vehicle 702 concurrently with adjusting the acceleration value and/or the position (e.g., a lateral position) of the vehicle 702, where the visual, haptic, and/or auditory indication(s) may inform the driver of an intent of the vehicle 702 with respect to the driving event. At 1214, the apparatus 1201 may output an indication of the adjusted acceleration value and/or the adjusted position of the vehicle.

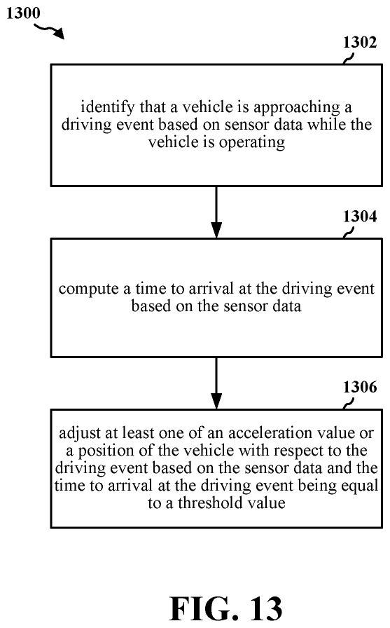

FIG. 13 is a flowchart 1300 of a method of driving assistance. The method may be performed by an apparatus (e.g., the UE 104, the UE 402, the first UE 504, the second UE 506, the vehicle 702, the apparatus 1201, the apparatus 1504). The method may be associated with various advantages at a vehicle, such as informing a driver of the vehicle of an intention of the vehicle with respect to a driving event. In an example, the method may be performed by the TTDE component 198.

At 1302, the apparatus (e.g., a vehicle, a component of a vehicle) identifies that a vehicle is approaching a driving event based on sensor data while the vehicle is operating. For example, FIG. 12 at 1202 shows that the apparatus 1201 may identify that a vehicle is approaching a driving event based on sensor data while the vehicle is operating. In an example, the vehicle may be the vehicle 702. In an example, the driving event may be or include aspects described above in the description of FIGS. 10A-10D and 11A-11D. In another example, the sensor data may be or include data generated by the sensor(s) 706. In an example, 1302 may be performed by the TTDE component 198.

At 1304, the apparatus (e.g., a vehicle, a component of a vehicle) computes a time to arrival at the driving event based on the sensor data. For example, FIG. 12 shows that the apparatus 1201 may compute a TTDE based on the sensor data. In an example, computing the time to arrival at the driving event may include aspects described above in connection with FIGS. 8 and 9 (e.g., calculate the TTI at 820). In an example, 1304 may be performed by the TTDE component 198.

At 1306, the apparatus (e.g., a vehicle, a component of a vehicle) adjusts at least one of an acceleration value or a position of the vehicle with respect to the driving event based on the sensor data and the time to arrival at the driving event being equal to a threshold value. For example, FIG. 12 at 1208 shows that the apparatus 1201 may adjust an acceleration value and/or a position (e.g., a lateral position) of a vehicle with respect to a driving event based on sensor data and a TTDE being equal to a threshold value. In an example, adjusting the at least one of the acceleration value or the position of the vehicle with respect to the driving event may include aspects described above in the description of FIGS. 10A-10D and 11A-11D. In an example, 1306 may be performed by the TTDE component 198.

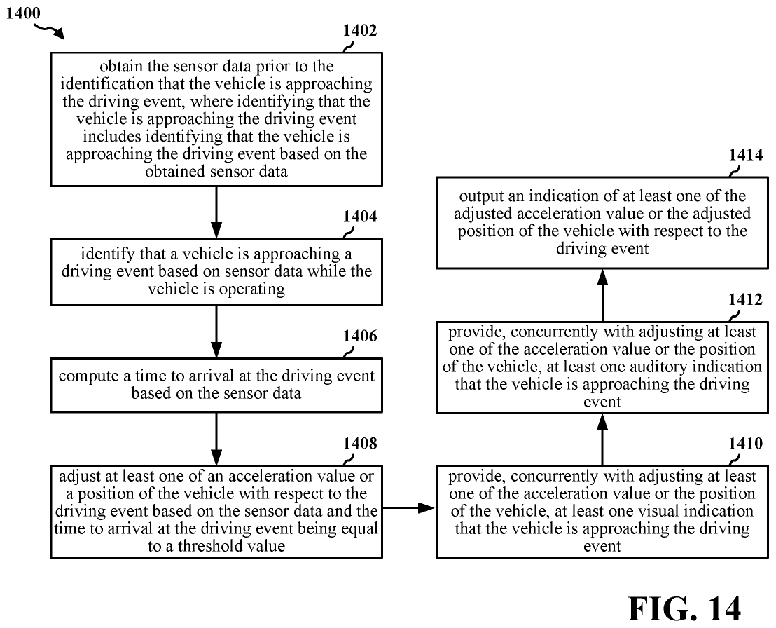

FIG. 14 is a flowchart 1400 of a method of driving assistance. The method may be performed by an apparatus (e.g., the UE 104, the UE 402, the first UE 504, the second UE 506, the vehicle 702, the apparatus 1201 the apparatus 1504). The method may be associated with various advantages at a vehicle, such as informing a driver of the vehicle of an intention of the vehicle with respect to a driving event. In an example, the method (including the various aspects detailed below) may be performed by the TTDE component 198.

At 1404, the apparatus (e.g., a vehicle, a component of a vehicle) identifies that a vehicle is approaching a driving event based on sensor data while the vehicle is operating. For example, FIG. 12 at 1202 shows that the apparatus 1201 may identify that a vehicle is approaching a driving event (i.e., a location of the driving event) based on sensor data while the vehicle is operating. In an example, the vehicle may be the vehicle 702. In an example, the driving event may be or include aspects described above in the description of FIGS. 10A-10D and 11A-11D. In another example, the sensor data may be or include data generated by the sensor(s) 706. In an example, 1404 may be performed by the TTDE component 198.

At 1406, the apparatus (e.g., a vehicle, a component of a vehicle) computes a time to arrival at the driving event based on the sensor data. For example, FIG. 12 shows that the apparatus 1201 may compute a TTDE based on the sensor data. In an example, computing the time to arrival at the driving event may include aspects described above in connection with FIGS. 8 and 9 (e.g., calculate the TTI at 820). In an example, 1406 may be performed by the TTDE component 198.

At 1408, the apparatus (e.g., a vehicle, a component of a vehicle) adjusts at least one of an acceleration value or a position of the vehicle with respect to the driving event based on the sensor data and the time to arrival at the driving event being equal to a threshold value. For example, FIG. 12 at 1208 shows that the apparatus 1201 may adjust an acceleration value and/or a position (e.g., a lateral position) of a vehicle with respect to a driving event based on sensor data and a TTDE being equal to a threshold value. In an example, adjusting the at least one of an acceleration value or a position of the vehicle with respect to the driving event may include aspects described above in the description of FIGS. 10A-10D and 11A-11D. In an example, 1408 may be performed by the TTDE component 198.

In one aspect, identifying that the vehicle is approaching the driving event may include: detecting that the vehicle is moving toward the driving event and that the vehicle is within a threshold distance of the driving event. For example, identifying that the vehicle is approaching the driving event at 1204 may include detecting that the vehicle is moving toward the driving event and that the vehicle is within a threshold distance of the driving event.

In one aspect, at 1402, the apparatus (e.g., a vehicle, a component of a vehicle) may obtain the sensor data prior to the identification that the vehicle is approaching the driving event, where identifying that the vehicle is approaching the driving event may include identifying that the vehicle is approaching the driving event based on the obtained sensor data. For example, FIG. 12 at 1202 shows that the apparatus may obtain sensor data prior to identifying that the vehicle is approaching the driving event. Furthermore, FIG. 12 at 1204 shows that identifying that the vehicle is approaching the driving event may be based on the obtained sensor data. In an example, 1402 may be performed by the TTDE component 198.

In one aspect, the vehicle may be operating in a self-driving mode while approaching the driving event. For example, the vehicle 702 may operate in a self-driving mode via the autonomous driving system 740.

In one aspect, the vehicle may be operating in a driver-assisted mode while approaching the driving event. For example, the vehicle 702 may operate in a driver-assisted mode via the semi-autonomous driving system 742.

In one aspect, identifying that the vehicle is approaching the driving event may include identifying that the vehicle is approaching an intersection. For example, FIGS. 10A-10D show that the vehicle 702 may identify that the vehicle 702 is approaching the intersection 1002.

In one aspect, adjusting the acceleration value with respect to the driving event may include causing the vehicle to accelerate or decelerate with respect to the intersection. For example, FIGS. 10A-10D show that the vehicle 702 may accelerate or decelerate with respect to the intersection 1002.

In one aspect, causing the vehicle to accelerate or decelerate with respect to the intersection may include causing an acceleration jerk or a deceleration jerk. For example, FIG. 9 at 902 and at 906 show that causing the vehicle 702 to accelerate or decelerate may include causing an acceleration jerk or a deceleration jerk, respectively.

In one aspect, computing the time to arrival at the driving event may include computing a first time to a stop position (e.g., a location of a road marking) associated with the intersection. For example, FIGS. 10A-10D show that computing the time to arrival at the driving event may include computing a time to the stop line 1004 of the intersection 1002.

In one aspect, identifying that the vehicle is approaching the driving event may include identifying that the vehicle is approaching an obstacle on a road. For example, FIGS. 11A-11D show that the vehicle 702 may identify that the vehicle 702 is approaching an obstacle 1102 on a road.

In one aspect, adjusting the position of the vehicle with respect to the driving event may include adjusting the position of the vehicle such that the vehicle avoids the obstacle. For example, FIGS. 11A-11D show that the vehicle 702 may adjust a position of the vehicle 702 such that the vehicle 702 avoids the obstacle 1102.

In one aspect, at least one of the acceleration value or the position of the vehicle may be adjusted when the time to arrival at the driving event equals the threshold value. For example, FIG. 8 at 826 and at 830 show that an acceleration value and/or position of a vehicle may be adjusted when a TTI equals a threshold. Furthermore, FIGS. 10A-10D and 11A-11D show that at least one of the acceleration value or the position of the vehicle may be adjusted when the time to arrival at the driving event equals the threshold value.

In one aspect, at least one of the acceleration value or the position of the vehicle may be adjusted prior to the vehicle reaching the driving event. For example, FIGS. 10A-10D and 11A-11D show that at least one of the acceleration value or the position of the vehicle 702 may be adjusted prior to the vehicle 702 reaching a driving event.

In one aspect, at 1410, the apparatus (e.g., a vehicle, a component of a vehicle) may provide, concurrently with adjusting at least one of the acceleration value or the position of the vehicle, at least one visual indication that the vehicle is approaching the driving event. For example, FIG. 12 at 1212 shows that the apparatus 1201 may provide a visual indication that the vehicle is approaching a driving event concurrently with adjusting at least one of the acceleration value or the position of the vehicle. In an example, the visual indication may be provided via the visual feedback device(s) 746. In an example, 1410 may be performed by the TTDE component 198.

In one aspect, at 1412, the apparatus (e.g., a vehicle, a component of a vehicle) may provide, concurrently with adjusting at least one of the acceleration value or the position of the vehicle, at least one auditory indication that the vehicle is approaching the driving event. For example, FIG. 12 at 1212 shows that the apparatus 1201 may provide an auditory indication that the vehicle is approaching a driving event concurrently with adjusting at least one of the acceleration value or the position of the vehicle. In an example, the visual indication may be provided via the auditory feedback device(s) 748. In an example, 1412 may be performed by the TTDE component 198.

In one aspect, at 1414, the apparatus (e.g., a vehicle, a component of a vehicle) may output an indication of at least one of the adjusted acceleration value or the adjusted position of the vehicle with respect to the driving event. For example, FIG. 12 at 1214 shows that that the apparatus 1201 may output an indication of an adjusted acceleration value and/or an adjusted position of the vehicle. In an example, the indication may be output relative to a default path of the vehicle. In an example, 1414 may be performed by the TTDE component 198.

In one aspect, outputting the indication of at least one of the adjusted acceleration value or the adjusted position of the vehicle with respect to the driving event may include transmitting, via at least one of the transceiver or the antenna, the indication of at least one of the adjusted acceleration value or the adjusted position of the vehicle with respect to the driving event. For example, FIG. 12 at 1210 shows that the apparatus 1201 may transmit an indication of the adjusted acceleration value and/or the adjust position of the vehicle.

In one aspect, outputting the indication of at least one of the adjusted acceleration value or the adjusted position of the vehicle with respect to the driving event may include storing, in the memory or a cache, the indication of at least one of the adjusted acceleration value or the adjusted position of the vehicle with respect to the driving event. For example, outputting the indication of the adjusted acceleration value and/or the adjusted position of the vehicle at 1214 may include storing, in a memory or a cache, the indication of the adjusted acceleration value and/or the adjusted position of the vehicle in a memory or a cache.

In one aspect, outputting the indication of at least one of the adjusted acceleration value or the adjusted position of the vehicle with respect to the driving event includes outputting the indication of at least one of the adjusted acceleration value or the adjusted position of the vehicle with respect to the driving event to at least one system of the vehicle. For example, the indication may be output to the data store(s) 714, the communication system(s) 718, one or more of the vehicle systems 722, one or more of the driver assistance systems 738, and/or one or more of the driver feedback devices 744. In one example, the indication may be utilized for insurance purposes. In another example, the indication may be utilized for dynamic map updates (e.g., updating the map(s) 716). In yet another example, the indication may be presented (e.g., via the visual feedback device(s) 746) to the driver of the vehicle at a time occurring after the driving event.

In one aspect, identifying that the vehicle is approaching the driving event may include identifying at least one of a color or a symbol of a traffic signal at an intersection, and the apparatus may predict whether at least one of the color or the symbol of the traffic signal will change prior to the vehicle reaching the intersection, where adjusting at least one of the acceleration value or the position of the vehicle may include adjusting, at a time instance at which the time to arrival equals the threshold value, at least one of the acceleration value or the position of the vehicle based on the prediction. For instance, if the traffic signal is red at the time instance, but the traffic signal is predicted to change from red to green within a relatively short period of time (e.g., a few milliseconds) after the time instance, the vehicle may implement the green light actuator behavior at the time instance.

In one aspect, adjusting at least one of the acceleration value or the position of the vehicle may include adjusting at least one of the acceleration value or the position of the vehicle at a time instance at which the time to arrival equals the threshold value such that the adjustment of at least one of the acceleration value or the position of the vehicle is capable of being overridden prior to the vehicle reaching the driving event. For example, an intended behavior of the vehicle may be overridden by the driver (e.g., by accelerating or decelerating the vehicle, changing a position of the vehicle, etc.).

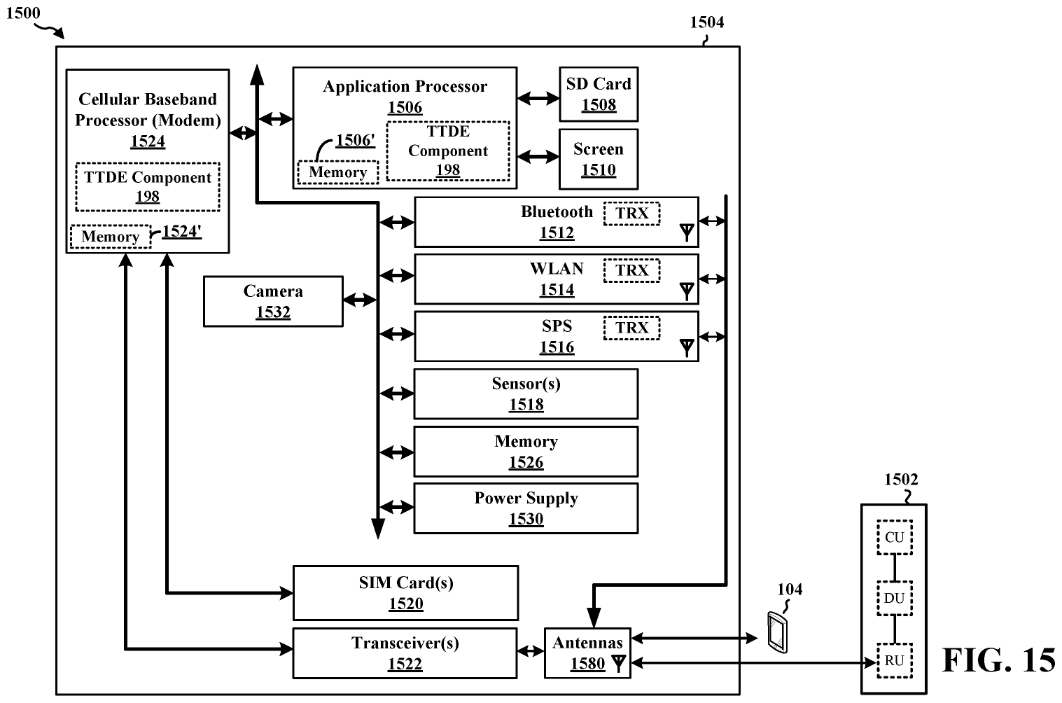

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see UE 350 of FIG. 3) and include the additional modules of the apparatus 1504.

As discussed supra, the TTDE component 198 may be configured to identify that a vehicle is approaching a driving event based on sensor data while the vehicle is operating. The TTDE component 198 may be configured to compute a time to arrival at the driving event based on the sensor data. The TTDE component 198 may be configured to adjust at least one of an acceleration value or a position of the vehicle with respect to the driving event based on the sensor data and the time to arrival at the driving event being equal to a threshold value. The TTDE component 198 may be configured to obtain the sensor data prior to the identification that the vehicle is approaching the driving event, where identifying that the vehicle is approaching the driving event includes identifying that the vehicle is approaching the driving event based on the obtained sensor data. The TTDE component 198 may be configured to provide, concurrently with adjusting at least one of the acceleration value or the position of the vehicle, at least one visual indication that the vehicle is approaching the driving event. The TTDE component 198 may be configured to provide, concurrently with adjusting at least one of the acceleration value or the position of the vehicle, at least one auditory indication that the vehicle is approaching the driving event. The TTDE component 198 may be configured to output an indication of at least one of the adjusted acceleration value or the adjusted position of the vehicle with respect to the driving event. The TTDE component 198 may be within the cellular baseband processor 1524, the application processor 1506, or both the cellular baseband processor 1524 and the application processor 1506. The TTDE component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, may include means for identifying that a vehicle is approaching a driving event based on sensor data while the vehicle is operating. In one configuration, the apparatus 1504, and in particular the cellular baseband processor 1524 and/or the application processor 1506, may include means for computing a time to arrival at the driving event based on the sensor data. In one configuration, the apparatus 1504, and in particular the cellular baseband processor 1524 and/or the application processor 1506, may include means for adjusting at least one of an acceleration value or a position of the vehicle with respect to the driving event based on the sensor data and the time to arrival at the driving event being equal to a threshold value. In one configuration, the apparatus 1504, and in particular the cellular baseband processor 1524 and/or the application processor 1506, may include means for obtaining the sensor data prior to the identification that the vehicle is approaching the driving event, where identifying that the vehicle is approaching the driving event includes identifying that the vehicle is approaching the driving event based on the obtained sensor data. In one configuration, the apparatus 1504, and in particular the cellular baseband processor 1524 and/or the application processor 1506, may include means for providing, concurrently with adjusting at least one of the acceleration value or the position of the vehicle, at least one visual indication that the vehicle is approaching the driving event. In one configuration, the apparatus 1504, and in particular the cellular baseband processor 1524 and/or the application processor 1506, may include means for providing, concurrently with adjusting at least one of the acceleration value or the position of the vehicle, at least one auditory indication that the vehicle is approaching the driving event. In one configuration, the apparatus 1504, and in particular the cellular baseband processor 1524 and/or the application processor 1506, may include means for outputting an indication of at least one of the adjusted acceleration value or the adjusted position of the vehicle with respect to the driving event. The means may be the TTDE component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

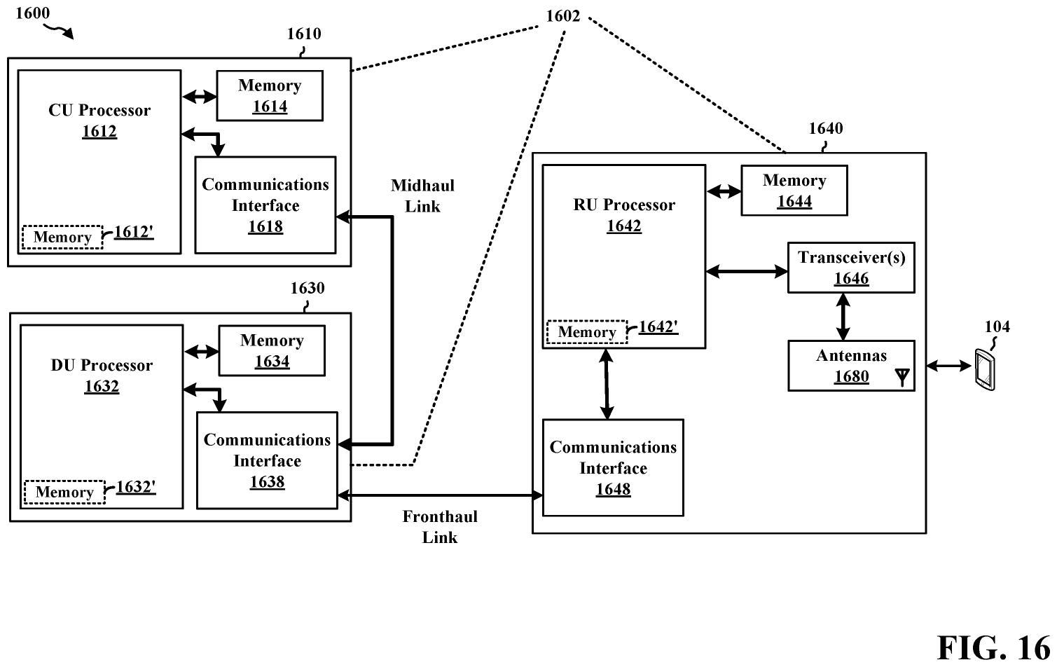

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. The network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

A vehicle may be equipped with a driver assistance system that enables the vehicle to operate autonomously or semi-autonomously from a person (i.e., a driver) in a driver's seat of the vehicle. For instance, when the vehicle approaches an intersection, the driver assistance system of the vehicle may identify the intersection based on sensor data and/or maps and determine whether the vehicle has a right-of-way (i.e., if a traffic light is green) at the intersection. If the vehicle has the right-of-way, the driver assistance system may cause the vehicle to drive through the intersection without input from the driver. If the vehicle does not have the right-of-way, the driver assistance system may cause the vehicle to stop at a stopping position (i.e., at a traffic marking before the traffic light) of the intersection without input from the driver.

If the driver assistance system erroneously determines that the vehicle has the right-of-way (i.e., the traffic light is red and the driver assistance system identifies the traffic light as green) or if the driver assistance system erroneously determines that the vehicle does not have the right-of-way (i.e., the traffic light is green and the driver assistance system identifies the traffic light as red), the driver may take action causing the vehicle to stop at the stopping position or action causing the vehicle to drive through the intersection, respectively. The driver assistance system may visually indicate (e.g., on a display, such as a center console of the vehicle) an intent to proceed through an intersection or stop at the intersection to the driver; however, visual indications may be missed by the driver.

Various technologies pertaining to driver notifications during driving events are described herein. In an example, an apparatus identifies that a vehicle is approaching a driving event based on sensor data while the vehicle is operating. The apparatus computes a time to arrival at the driving event based on the sensor data. The apparatus adjusts at least one of an acceleration value or a position of the vehicle with respect to the driving event based on the sensor data and the time to arrival at the driving event being equal to a threshold value. Vis-à-vis adjusting at least one of the acceleration value or the position of the vehicle with respect to the driving event when the time to arrival equals the threshold value, the apparatus may inform the driver of an intention of the vehicle with respect to the driving event (e.g., approaching an intersection) in a timely manner that enables the driver to take action if the driver so chooses. Furthermore, the apparatus may condition the driver over time to expect adjustment of the acceleration value and/or the position at a time instance at which the time to arrival equals the threshold value. Thus, the apparatus may provide the driver with the opportunity to determine whether the vehicle is performing in a suitable or desired manner and as such, the driver remains “in the loop” with respect to navigation decisions made by the vehicle.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of driving assistance, comprising: identifying that a vehicle is approaching a driving event based on sensor data while the vehicle is operating; computing a time to arrival at the driving event based on the sensor data; and adjusting at least one of an acceleration value or a position of the vehicle with respect to the driving event based on the sensor data and the time to arrival at the driving event being equal to a threshold value.

Aspect 2 is the method of aspect 1, wherein identifying that the vehicle is approaching the driving event comprises: detecting that the vehicle is moving toward the driving event and that the vehicle is within a threshold distance of the driving event.

Aspect 3 is the method of any of aspects 1-2, further comprising: obtaining the sensor data prior to the identification that the vehicle is approaching the driving event, wherein identifying that the vehicle is approaching the driving event comprises identifying that the vehicle is approaching the driving event based on the obtained sensor data.

Aspect 4 is the method of any of aspects 1-3, wherein the vehicle is operating in a self-driving mode while approaching the driving event.

Aspect 5 is the method of any of aspects 1-3, wherein the vehicle is operating in a driver-assisted mode while approaching the driving event.

Aspect 6 is the method of any of aspects 1-5, wherein identifying that the vehicle is approaching the driving event comprises identifying that the vehicle is approaching an intersection.

Aspect 7 is the method of aspect 6, wherein adjusting the acceleration value with respect to the driving event comprises causing the vehicle to accelerate or decelerate with respect to the intersection.

Aspect 8 is the method of aspect 7, wherein causing the vehicle to accelerate or decelerate with respect to the intersection comprises causing an acceleration jerk or a deceleration jerk.

Aspect 9 is the method of any of aspects 6-8, wherein computing the time to arrival at the driving event comprises computing a first time to a stop position associated with the intersection.

Aspect 10 is the method of any of aspects 1-5, wherein identifying that the vehicle is approaching the driving event comprises identifying that the vehicle is approaching an obstacle on a road.

Aspect 11 is the method of aspect 10, wherein adjusting the position of the vehicle with respect to the driving event comprises adjusting the position of the vehicle such that the vehicle avoids the obstacle.

Aspect 12 is the method of any of aspects 1-11, wherein at least one of the acceleration value or the position of the vehicle is adjusted when the time to arrival at the driving event equals the threshold value.

Aspect 13 is the method of any of aspects 1-12, wherein at least one of the acceleration value or the position of the vehicle is adjusted prior to the vehicle reaching the driving event.

Aspect 14 is the method of any of aspects 1-13, further comprising: providing, concurrently with adjusting at least one of the acceleration value or the position of the vehicle, at least one visual indication that the vehicle is approaching the driving event.

Aspect 15 is the method of any of aspects 1-14, further comprising: providing, concurrently with adjusting at least one of the acceleration value or the position of the vehicle, at least one auditory indication that the vehicle is approaching the driving event.

Aspect 16 is the method of any of aspects 1-15, further comprising: outputting an indication of at least one of the adjusted acceleration value or the adjusted position of the vehicle with respect to the driving event.

Aspect 17 is the method of aspect 16, wherein outputting the indication of at least one of the adjusted acceleration value or the adjusted position of the vehicle with respect to the driving event comprises transmitting the indication of at least one of the adjusted acceleration value or the adjusted position of the vehicle with respect to the driving event.

Aspect 18 is the method of aspect 16, wherein outputting the indication of at least one of the adjusted acceleration value or the adjusted position of the vehicle with respect to the driving event comprises storing, in a memory or a cache, the indication of at least one of the adjusted acceleration value or the adjusted position of the vehicle with respect to the driving event.

Aspect 19 is the method of aspect 16, wherein outputting the indication of at least one of the adjusted acceleration value or the adjusted position of the vehicle with respect to the driving event comprises outputting the indication of at least one of the adjusted acceleration value or the adjusted position of the vehicle with respect to the driving event to at least one system of the vehicle.

Aspect 20 is the method of any of aspects 1-9 or 12-19, wherein identifying that the vehicle is approaching the driving event comprises identifying at least one of a color or a symbol of a traffic signal at an intersection, further comprising predicting whether at least one of the color or the symbol of the traffic signal will change prior to the vehicle reaching the intersection, wherein adjusting at least one of the acceleration value or the position of the vehicle comprises adjusting, at a time instance at which the time to arrival equals the threshold value, at least one of the acceleration value or the position of the vehicle based on the prediction.

Aspect 21 is the method of any of aspects 1-20, wherein adjusting at least one of the acceleration value or the position of the vehicle comprises adjusting at least one of the acceleration value or the position of the vehicle at a time instance at which the time to arrival equals the threshold value such that the adjustment of at least one of the acceleration value or the position of the vehicle is capable of being overridden prior to the vehicle reaching the driving event.

Aspect 22 is an apparatus for wireless communication at a device comprising a memory and at least one processor coupled to the memory and based at least in part on information stored in the memory, the at least one processor is configured to perform a method in accordance with any of aspects 1-21.

Aspect 23 is an apparatus for wireless communications, comprising means for performing a method in accordance with any of aspects 1-21.

Aspect 24 is the apparatus of aspect 22 or 23 further comprising at least one of a transceiver or an antenna coupled to the at least one processor, wherein to identify that the vehicle is approaching the driving event, the at least one processor is configured to identify that the vehicle is approaching the driving event via at least one of the transceiver or the antenna.

Aspect 25 is a computer-readable medium (e.g., a non-transitory computer-readable medium) comprising instructions that, when executed by an apparatus, cause the apparatus to perform a method in accordance with any of aspects 1-21.

What is claimed is:

1. An apparatus for wireless communication at a device, comprising:
a memory; and
at least one processor coupled to the memory and, based at least in part on information stored in the memory, the at least one processor is configured to:
identify that a vehicle is approaching a driving event based on sensor data while the vehicle is operating;
compute a time to arrival at the driving event based on the sensor data; and
adjust at least one of an acceleration value or a position of the vehicle with respect to the driving event based on the sensor data and the time to arrival at the driving event being equal to a threshold value.

2. The apparatus of claim 1, wherein to identify that the vehicle is approaching the driving event, the at least one processor is configured to: detect that the vehicle is moving toward the driving event and that the vehicle is within a threshold distance of the driving event.

3. The apparatus of claim 1, wherein the at least one processor is further configured to:
obtain the sensor data prior to the identification that the vehicle is approaching the driving event, wherein to identify that the vehicle is approaching the driving event, the at least one processor is configured to identify that the vehicle is approaching the driving event based on the obtained sensor data.

4. The apparatus of claim 1, wherein the vehicle is operating in a self-driving mode while approaching the driving event.

5. The apparatus of claim 1, wherein the vehicle is operating in a driver-assisted mode while approaching the driving event.

6. The apparatus of claim 1, wherein to identify that the vehicle is approaching the driving event, the at least one processor is configured to identify that the vehicle is approaching an intersection.

7. The apparatus of claim 6, wherein to adjust the acceleration value with respect to the driving event, the at least one processor is configured to cause the vehicle to accelerate or decelerate with respect to the intersection.

8. The apparatus of claim 7, wherein to cause the vehicle to accelerate or decelerate with respect to the intersection, the at least one processor is configured to cause an acceleration jerk or a deceleration jerk.

9. The apparatus of claim 6, wherein to compute the time to arrival at the driving event, the at least one processor is configured to compute a first time to a stop position associated with the intersection.

10. The apparatus of claim 1, wherein to identify that the vehicle is approaching the driving event, the at least one processor is configured to identify that the vehicle is approaching an obstacle on a road.

11. The apparatus of claim 10, wherein to adjust the position of the vehicle with respect to the driving event, the at least one processor is configured to adjust the position of the vehicle such that the vehicle avoids the obstacle.

12. The apparatus of claim 1, wherein to adjust at least one of the acceleration value or the position of the vehicle, the at least one processor is configured to adjust at least one of the acceleration value or the position of the vehicle when the time to arrival at the driving event equals the threshold value.

13. The apparatus of claim 1, wherein to adjust at least one of the acceleration value or the position of the vehicle, the at least one processor is configured to adjust at least one of the acceleration value or the position of the vehicle prior to the vehicle reaching the driving event.

14. The apparatus of claim 1, wherein the at least one processor is further configured to:
provide, concurrently with the adjustment of at least one of the acceleration value or the position of the vehicle, at least one visual indication that the vehicle is approaching the driving event.

15. The apparatus of claim 1, wherein the at least one processor is further configured to:
provide, concurrently with the adjustment of at least one of the acceleration value or the position of the vehicle, at least one auditory indication that the vehicle is approaching the driving event.

16. The apparatus of claim 1, wherein the at least one processor is further configured to:
output an indication of at least one of the adjusted acceleration value or the adjusted position of the vehicle with respect to the driving event.

17. The apparatus of claim 16, further comprising at least one of a transceiver or an antenna coupled to the at least one processor, wherein to output the indication of at least one of the adjusted acceleration value or the adjusted position of the vehicle with respect to the driving event, the at least one processor is configured to transmit, via at least one of the transceiver or the antenna, the indication of at least one of the adjusted acceleration value or the adjusted position of the vehicle with respect to the driving event.

18. The apparatus of claim 16, wherein to output the indication of at least one of the adjusted acceleration value or the adjusted position of the vehicle with respect to the driving event, the at least one processor is configured to store, in the memory or a cache, the indication of at least one of the adjusted acceleration value or the adjusted position of the vehicle with respect to the driving event.

19. The apparatus of claim 16, wherein to output the indication of at least one of the adjusted acceleration value or the adjusted position of the vehicle with respect to the driving event, the at least one processor is configured to output the indication of at least one of the adjusted acceleration value or the adjusted position of the vehicle with respect to the driving event to at least one system of the vehicle.

20. The apparatus of claim 1, wherein to identify that the vehicle is approaching the driving event, the at least one processor is configured to identify at least one of a color or a symbol of a traffic signal at an intersection, wherein the at least one processor is further configured to:
predict whether at least one of the color or the symbol of the traffic signal will change prior to the vehicle reaching the intersection, wherein to adjust at least one of the acceleration value or the position of the vehicle, the at least one processor is configured to adjust, at a time instance at which the time to arrival equals the threshold value, at least one of the acceleration value or the position of the vehicle based on the prediction.

21. The apparatus of claim 1, wherein to adjust at least one of the acceleration value or the position of the vehicle, the at least one processor is configured to adjust at least one of the acceleration value or the position of the vehicle at a time instance at which the time to arrival equals the threshold value such that the adjustment of at least one of the acceleration value or the position of the vehicle is capable of being overridden prior to the vehicle reaching the driving event.

22. A method of driving assistance at a device, comprising:
identifying that a vehicle is approaching a driving event based on sensor data while the vehicle is operating;
computing a time to arrival at the driving event based on the sensor data; and
adjusting at least one of an acceleration value or a position of the vehicle with respect to the driving event based on the sensor data and the time to arrival at the driving event being equal to a threshold value.

23. The method of claim 22, wherein identifying that the vehicle is approaching the driving event comprises: detecting that the vehicle is moving toward the driving event and that the vehicle is within a threshold distance of the driving event.

24. The method of claim 22, further comprising:
obtaining the sensor data prior to the identification that the vehicle is approaching the driving event, wherein identifying that the vehicle is approaching the driving event comprises identifying that the vehicle is approaching the driving event based on the obtained sensor data.

25. The method of claim 22, wherein the vehicle is operating in a self-driving mode while approaching the driving event.

26. The method of claim 22, wherein the vehicle is operating in a driver-assisted mode while approaching the driving event.

27. The method of claim 22, wherein identifying that the vehicle is approaching the driving event comprises identifying that the vehicle is approaching an intersection.

28. The method of claim 27, wherein adjusting the acceleration value with respect to the driving event comprises causing the vehicle to accelerate or decelerate with respect to the intersection.

29. An apparatus for wireless communication at device, comprising:
means for identifying that a vehicle is approaching a driving event based on sensor data while the vehicle is operating;
means for computing a time to arrival at the driving event based on the sensor data; and
means for adjusting at least one of an acceleration value or a position of the vehicle with respect to the driving event based on the sensor data and the time to arrival at the driving event being equal to a threshold value.

30. A computer-readable medium storing computer executable code at a device, the computer executable code when executed by at least one processor causes the at least one processor to:
identify that a vehicle is approaching a driving event based on sensor data while the vehicle is operating;
compute a time to arrival at the driving event based on the sensor data; and
adjust at least one of an acceleration value or a position of the vehicle with respect to the driving event based on the sensor data and the time to arrival at the driving event being equal to a threshold value.
